(19) United States
(12) Patent Application Publication
(10) Pub. No.: US 2018/0352434 A1
(43) Pub. Date: Dec. 6, 2018

(54) WIRELESS COMMUNICATION SYSTEM, BEACON DEVICE, INFORMATION PROCESSING TERMINAL, AND BEACON DEVICE AUTHENTICATION METHOD

(71) Applicant: Renesas Electronics Corporation, Tokyo (JP)

(72) Inventors: Tomohiko OHTSU, Tokyo (JP); Shinichi YAMADA, Tokyo (JP); Yuichi MARUYAMA, Tokyo (JP); Hideyuki WAKADA, Tokyo (JP); Yoshihiro HAYASHI, Tokyo (JP); Taku FUJIWARA, Tokyo (JP)

(21) Appl. No.: 15/955,831

(22) Filed: Apr. 18, 2018

(30) Foreign Application Priority Data
Jun. 5, 2017 (JP) 2017-110914

(51) Int. Cl. H04W 12/06; H04L 29/06

(52) U.S. Cl. CPC H04W 12/06; H04L 2209/80; H04L 63/0435

(57) ABSTRACT

Provided is a technology for a technology for easily inhibiting a wireless signal from being spoofed. A wireless communication system includes a beacon device and an information processing terminal. The beacon device includes a first communication circuit for transmitting a beacon signal to the information processing terminal in accordance with a predetermined transmission interval pattern. The information processing terminal includes a second communication circuit, a first storage device, and a control device. The second communication circuit receives the beacon signal from the beacon device. The first storage device stores the predetermined transmission interval pattern. The control device authenticates the beacon device by comparing a reception interval pattern of the beacon signal received by the second communication circuit with the predetermined transmission interval pattern stored in the first storage device.

### CROSS-REFERENCE TO RELATED APPLICATIONS

The disclosure of Japanese Patent Application No. 2017-110914 filed on Jun. 5, 2017 including the specification, drawings, and abstract is incorporated herein by reference in its entirety.

### BACKGROUND

The present disclosure relates to wireless communication and more particularly to an authentication process in wireless communication.

In recent years, a beacon device capable of transmitting a beacon signal to an information processing terminal owned by a user is supplied and disposed, for example, at a supermarket, a convenience store, a department store, or a specialty store. Upon receiving the beacon signal from the beacon device, the information processing terminal is capable, for example, of acquiring product information from the beacon signal through an application installed on the information processing terminal, and displaying the product information on a display of the information processing terminal.

In general, the beacon signal is wirelessly transmitted and received between the beacon device and the information processing terminal. Various wireless communication technologies, which are not limited to the transmission and reception of the beacon signal, are proposed. A radio station disclosed, for example, in Japanese Unexamined Patent Application Publication (Translation of PCT Application) No. 2009-529301, which relates to wireless communication based on the IEEE 802.11 standard, is woken up from a power-saving mode by only an interval corresponding to the delivery time for a selected type of traffic that is to be received (refer to “Abstract”).

### SUMMARY

Meanwhile, there has been a problem where a beacon signal is spoofed by a malicious third party. For example, a malicious third party detects and duplicates a beacon signal transmitted from a beacon device in order to obtain a coupon outside a store although the coupon is intrinsically obtainable only at the store.

A technology for attaching an electronic signature to a beacon signal by using a server (certificate authority) is proposed to prevent the above-described spoofing issue. However, implementing this technology requires a considerable amount of time and cost. What is therefore demanded is a technology for easily inhibiting a malicious third party from spoofing a wireless signal.

The present disclosure has been made in view of the above circumstances and provides a technology for easily inhibiting a wireless signal from being spoofed.

Other problems and novel features will become apparent from the following description and from the accompanying drawings.

According to an aspect of the present disclosure, there is provided a wireless communication system including a beacon device and an information processing terminal. The information processing terminal is wirelessly communicatively connected to the beacon device. The beacon device includes a first communication circuit. The first communication circuit transmits a beacon signal to the information processing terminal in accordance with a predetermined transmission interval pattern. The information processing terminal includes a second communication circuit, a first storage device, and a control device. The second communication circuit receives a beacon signal from the beacon device. The first storage device stores the predetermined transmission interval pattern. The control device authenticates the beacon device by comparing a reception interval pattern of the beacon signal received by the second communication circuit with the predetermined transmission interval pattern stored in the first storage device.

The wireless communication system according to an aspect of the present disclosure is capable of authenticating a beacon device with ease.

### BRIEF DESCRIPTION OF THE DRAWINGS

FIG. 1 is a diagram illustrating the technical idea of the present disclosure;

FIG. 2 is a schematic block diagram illustrating a configuration of a wireless communication system according to a first embodiment of the present disclosure;

FIGS. 3A and 3B are diagrams illustrating a transmission interval pattern;

FIG. 4 is a diagram illustrating an exemplary data structure of a beacon signal transmitted by a beacon device;

FIG. 5 is a sequence diagram (part 1) illustrating a communication process in the wireless communication system;

FIG. 6 is a sequence diagram (part 2) illustrating the communication process in the wireless communication system;

FIG. 7 is a diagram illustrating an exemplary data structure of a transmission pattern table;

FIG. 8 is a diagram illustrating an exemplary configuration of the wireless communication system according to a third embodiment of the present disclosure;

FIG. 9 is a block diagram illustrating an exemplary configuration of an information processing terminal;

FIG. 10 is a diagram illustrating an exemplary data structure of the transmission pattern table;

FIG. 11 is a sequence diagram illustrating the communication process in the wireless communication system;

FIG. 12 is a diagram illustrating the selection of a character string at the information processing terminal;

FIG. 13 is a diagram illustrating how the information processing terminal displays a character string received from another information processing terminal; and

FIG. 14 is a diagram illustrating how the information processing terminal receives a beacon signal transmission time point from a user.

### DETAILED DESCRIPTION

Embodiments of the technical idea of the present disclosure will now be described in detail with reference to the accompanying drawings. In the following description, like elements are designated by like reference numerals. The like elements have the same name and function. Therefore, the like elements will not be redundantly described in detail. The embodiments and modifications described below may be selectively combined as appropriate.

### Technical Idea

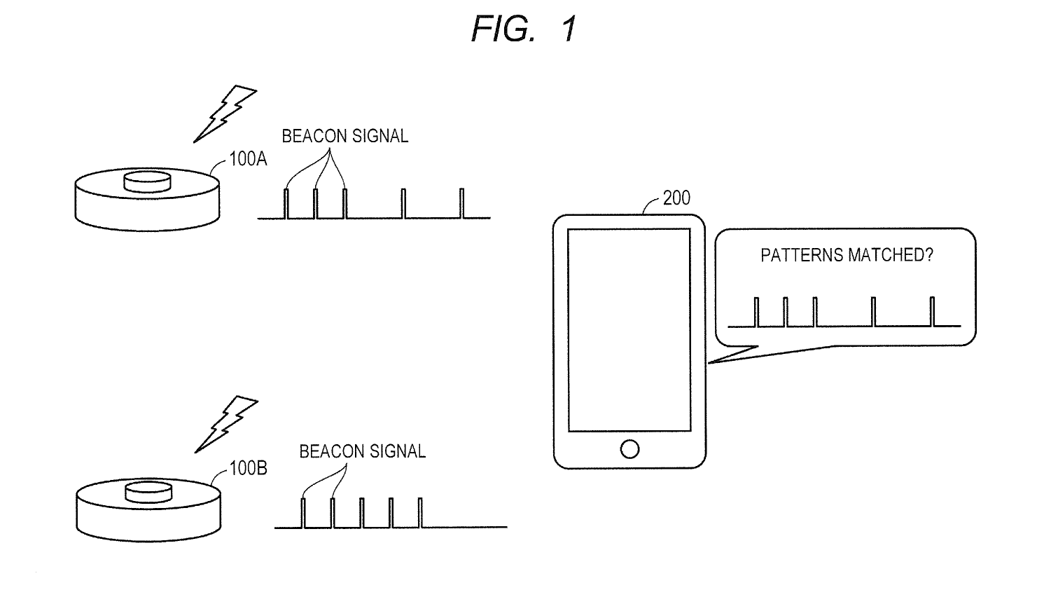

FIG. 1 is a diagram illustrating the technical idea of the present disclosure. Referring to FIG. 1, in an aspect, a beacon device 100A and an information processing device 200 establish wireless communication. The beacon device 100A transmits a beacon signal to the information processing terminal 200 in accordance with a predetermined transmission interval pattern.

The information processing terminal 200 stores in advance the predetermined transmission interval pattern in a storage device. Based on a reception interval pattern in which a beacon signal is received from the beacon device 100A and on the predetermined transmission interval pattern stored in the storage device, the information processing terminal 200 authenticates the beacon device 100A. More specifically, when the reception interval pattern matches the predetermined transmission interval pattern, the information processing terminal 200 recognizes that the beacon device 100A is a legitimate device.

The information processing terminal 200 extracts identification information (e.g., UUID, (Universally Unique IDentifier)) from a beacon signal outputted from the authenticated beacon device 100A. The information processing terminal 200 presents, to a user, information corresponding to the identification information. For example, the information processing terminal 200 transmits the extracted identification information to a server (not shown), acquires, from the server, a coupon corresponding to the identification information, and displays the acquired coupon on a display.

In another aspect, a beacon device 100B and the information processing device 200 establish wireless communication. The beacon device 100B outputs a beacon signal at predetermined intervals (e.g., at 100-msec intervals). The information processing terminal 200 compares a reception interval pattern in which a beacon signal is received from the beacon device 100B with the predetermined transmission interval pattern stored in the storage device. In the example of FIG. 1, the reception interval pattern does not match the predetermined transmission interval pattern. Therefore, the information processing terminal 200 recognizes that the beacon device 100B is an illegitimate device. Consequently, the information processing terminal 200 does not present, to the user, information corresponding to the identification information contained in the beacon signal outputted from the beacon device 100B.

As described above, based on a beacon signal reception interval pattern and on a stored transmission interval pattern, the information processing terminal 200 is able to authenticate a beacon device transmitting a beacon signal. Therefore, a business operator supplying the beacon device 100A is able to inhibit spoofing by a malicious third party through the use of a simple configuration. The configuration for implementing the above-described process is described in detail below.

### First Embodiment

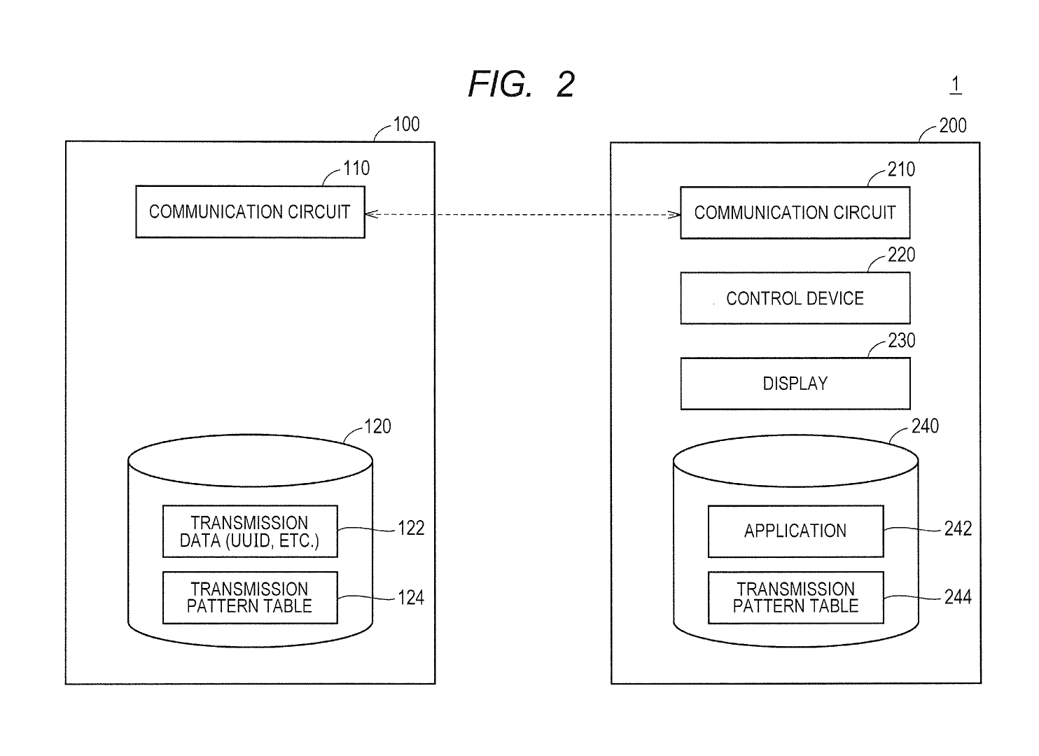

FIG. 2 is a schematic block diagram illustrating a configuration of a wireless communication system 1 according to a first embodiment of the present disclosure. Referring to FIG. 2, the wireless communication system 1 includes a beacon device 100 and an information processing terminal 200. In the example of FIG. 2, the wireless communication system 1 includes one beacon device 100. However, the wireless communication system 1 may include a plurality of beacon devices 100.

The beacon device 100 is disposed, for example, in a store in order to provide a service such as a mobile payment service. Alternatively, the beacon device 100 may be disposed, for example, on the ceiling of a passageway in a building in order to present information such as the notification of an event, the information about a discount coupon, and a route guidance in a building.

The information processing terminal 200 is, for example, a smartphone, a tablet, or other mobile terminal carried by a user. By using the information processing terminal 200, the user is able to receive a service provided by the beacon device 100.

### (Beacon Device)

The beacon device 100 includes a communication circuit 110 and a storage device 120.

The communication circuit 110 communicates with a later-described communication circuit 210. The communication circuits 110, 210 establish communication in accordance with a publicly-known wireless communication standard. For example, the communication circuits 110, 210 establish communication in accordance with the IEEE 802.15.1 (Bluetooth (registered trademark)) communication standard. From the viewpoint of power consumption, the communication circuits 110, 210 establish communication in accordance with the Bluetooth (registered trademark) Low Energy (BLE) communication standard for Bluetooth version 4.0 or later.

The storage device 120 stores transmission data 122 and a transmission pattern table 124. The transmission data 122 is to be transmitted to the information processing terminal 200. The storage device 120 is implemented by a nonvolatile memory. In another aspect in which electrical power is steadily supplied to the beacon device 100, the storage device 120 may be implemented by a volatile memory.

The transmission data 122 includes, for example, a UUID, a major ID, and a minor ID, which form advertising data of a beacon signal.

The transmission pattern table 124 retains a beacon signal transmission interval pattern (hereinafter referred to also as the “transmission interval pattern”). The communication circuit 110 outputs a beacon signal in accordance with the transmission interval pattern.

### (Transmission Pattern Table)

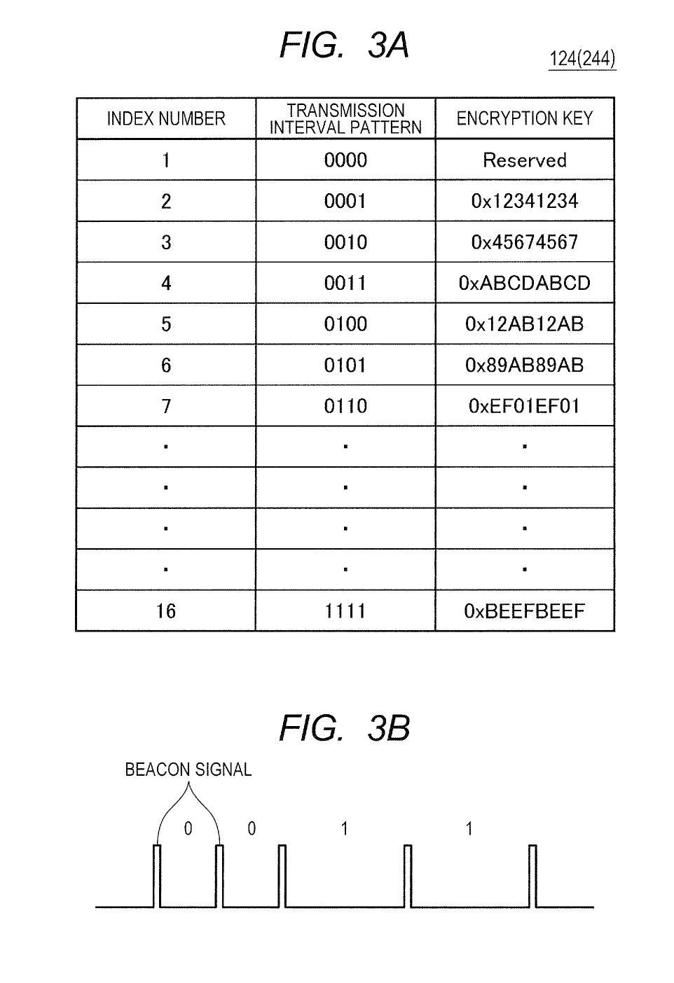

FIGS. 3A and 3B are diagrams illustrating the transmission interval pattern. FIG. 3A illustrates an exemplary data structure of the transmission pattern table 124. Referring to FIGS. 3A and 3B, the transmission pattern table 124 retains a plurality of sets of an index number, a transmission interval pattern, and an encryption key in association with each other.

The index number identifies each of a plurality of transmission interval patterns. In the example of FIGS. 3A and 3B, the transmission interval patterns are represented by 4-bit information. As an example, “0” denotes one second, whereas “1” denotes two seconds. In the case of a transmission interval pattern of “0011” at an index number of “4”, after outputting a beacon signal, the communication circuit 110 outputs a subsequent beacon signal in one second, in two seconds, in four seconds, in six seconds, in seven seconds, in eight seconds, and so on.

The transmission interval pattern may represent fixed time intervals (e.g., “0000” or “1111”) or unfixed time intervals. Further, the transmission interval pattern is not limited to 4-bit information, but may be information having one or more bits. In another aspect, the transmission interval pattern may be information merely indicative of transmission intervals (e.g., 2-second intervals).

The encryption key retains a character string for encrypting the transmission data 122. If, for example, a beacon signal is to be transmitted in a transmission interval pattern having an index number of “3”, the communication circuit 110 transmits the beacon signal containing data that is encrypted by a character string of “0x45674567”.

The communication circuit 110 is able to change the beacon signal transmission interval pattern from a first transmission interval pattern to a second transmission interval pattern. The first transmission interval pattern and the second transmission interval pattern are among the transmission interval patterns retained by the transmission pattern table 124. The communication circuit 110 may transmit a beacon signal by randomly changing the transmission interval pattern at predetermined intervals (e.g., at 10-second intervals).

### (Information Processing Terminal)

Referring again to FIG. 2, the information processing terminal 200 includes a communication circuit 210, a control device 220, a display 230, and a storage device 240.

The control device 220 is implemented, for example, by a CPU (Central Processing Unit). The control device 220 controls the operation of the information processing terminal 200.

The storage device 240 stores an application 242 and a transmission pattern table 244. The application 242 is distributed by a business operator who supplies the beacon device 100. For example, the user downloads the application 242 from a platform. In this instance, the information processing terminal 200 downloads the transmission pattern table 244 together with the application 242.

The transmission pattern table 244 retains the same data as the transmission pattern table 124 described with reference to FIGS. 3A and 3B. That is to say, it can be said that the information processing terminal 200 has the transmission pattern table 124 to be stored in the beacon device 100.

In a certain aspect, the control device 220 reads and executes the application 242, and presents to the display 230 a service corresponding to a beacon signal received from the beacon device 100. For example, the control device 220 transmits the UUID, which is contained in the beacon signal, to a server (not shown) managed by the business operator of the beacon device 100. The server transmits a coupon corresponding to the UUID to the information processing terminal 200. The control device 220 displays the received coupon on the display 230.

### (Beacon Signal)

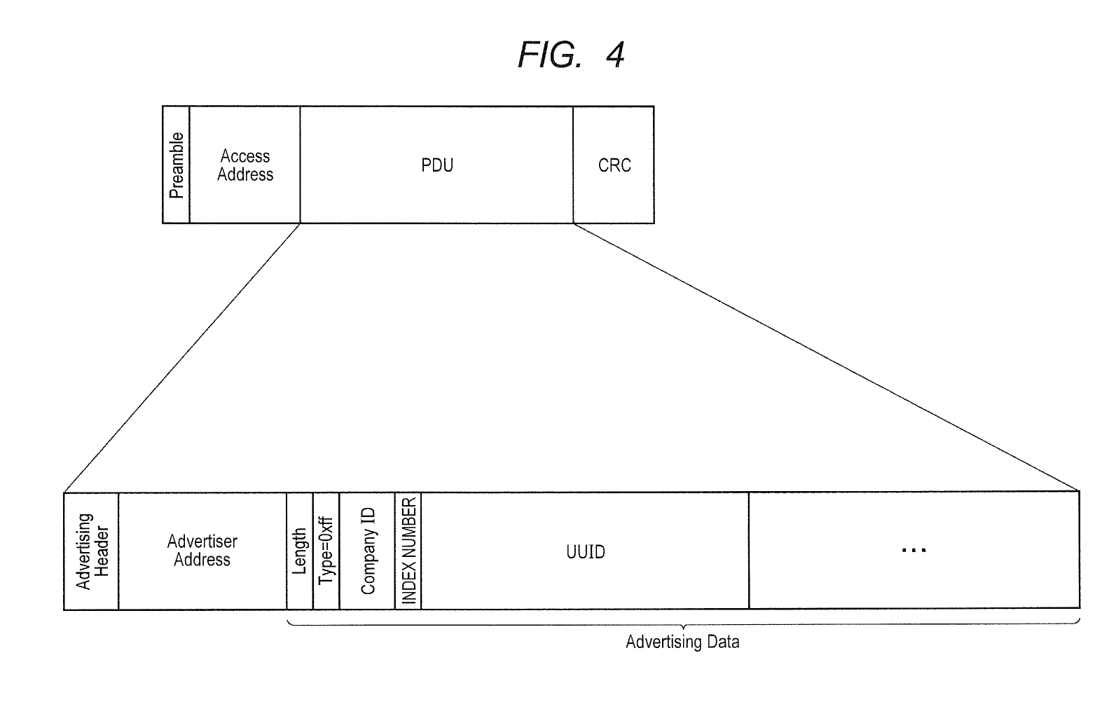

FIG. 4 illustrates an exemplary data structure of a beacon signal transmitted by the beacon device 100. The beacon signal shown in FIG. 4 is an advertising packet that includes a 1-byte preamble, a 4-byte access address, a protocol data unit (PDU), and a 3-byte CRC (Cyclic Redundancy Check) code. The preamble is used to achieve synchronization between packet detection and reception. The access address indicates a packet type. If the access address indicates an advertising packet, a fixed value is inputted as the access address.

The PDU includes a 2-byte header (advertising header), an advertiser address, and advertising data. The advertiser address indicates a transmitting end.

The advertising data includes a length (data length), a type, a company ID, an index number, and a UUID. The advertising data may further include data such as a major ID and a minor ID.

The type indicates the type of advertising packet. In the example of FIG. 4, the type “0xFF” denotes manufacturer specific data and indicates that the type is followed by the company ID. The company ID identifies a business operator who provides a service based on the use of the beacon device 100. The index number denotes an index number that is to be stored in the transmission pattern table 124 (244).

When the beacon signal is encrypted by the encryption key, the UUID and other advertising data except the index number are encrypted.

### (Authentication Process)

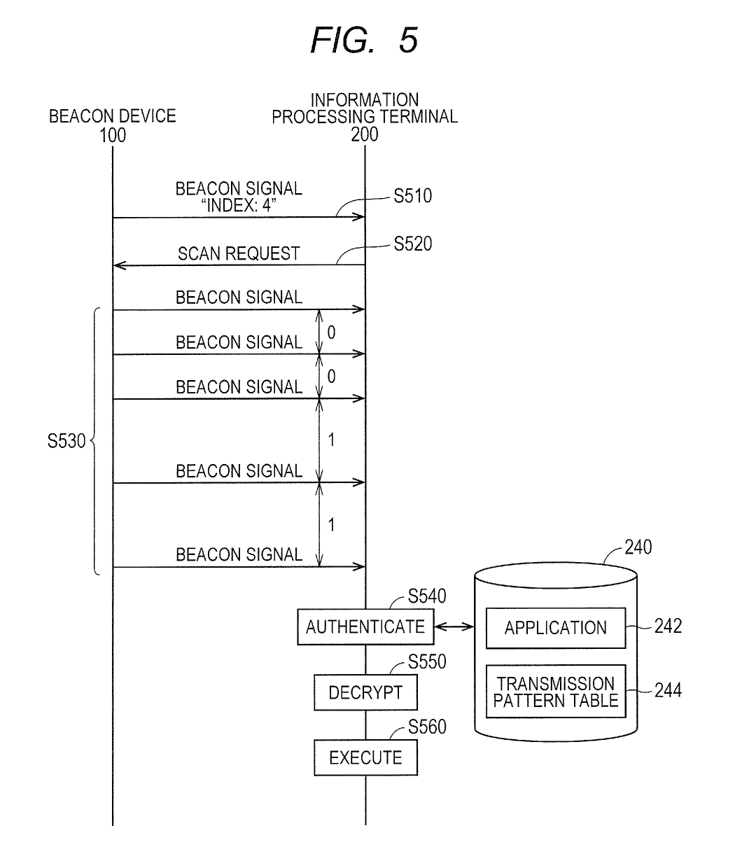

A process performed by the information processing terminal 200 to authenticate the beacon device 100 will now be described with reference to FIG. 5. In the description of the present disclosure, the “authentication” process is a process that is performed to verify whether the beacon device 100 is a legitimate device.

FIG. 5 is a sequence diagram illustrating a communication process in the wireless communication system 1. The process of the information processing terminal 200 that is illustrated in FIG. 5 is implemented by allowing the control device 220 to read and execute the application 242.

In the example of FIG. 5, the communication circuit 110 in the beacon device 100 transmits a beacon signal to the information processing terminal 200 in accordance with a transmission interval pattern of “0011”, which is among the transmission interval patterns stored in the transmission pattern table 124 and corresponds to an index number of “4”.

In step S510, the communication circuit 110 in the beacon device 100 transmits a beacon signal (advertising packet) containing an index number of “4” to the information processing terminal 200.

In step S520, the control device 220 references the transmission pattern table 244 to identify a transmission interval pattern of “0011”, which corresponds to the index number “4” contained in the received beacon signal. Further, the control device 220 transmits a scan request to the beacon device 100 in 150 msec after receiving the beacon signal.

In step S530, upon receiving the scan request, the communication circuit 110 starts transmitting a beacon signal to the information processing terminal 200 at a time point predetermined by the transmission interval pattern “0011”. As an example, the communication circuit 110 starts transmitting the beacon signal at the first bit “0” of the transmission interval pattern “0011”.

In the example of FIG. 5, after outputting a first beacon signal in step S530, the communication circuit 110 outputs a subsequent beacon signal in one second, in two seconds, in four seconds, in six seconds, and so on.

In another aspect, upon receiving the scan request, the communication circuit 110 may transmit a beacon signal at the end of a third period (e.g., a period of 1.5 seconds), which does not correspond to “0” or “1”.

In step S540, based on the beacon signal reception interval pattern in which a predetermined number of beacon signals are successively received as predetermined by the transmission interval pattern, the control device 220 authenticates whether the beacon device 100 is a legitimate device. In the above example, the transmission interval pattern has four bits. Therefore, the number of (predetermined number of) beacon signals required for forming the transmission interval pattern is five.

Consequently, the control device 220 authenticates the beacon device 100 by comparing the reception interval pattern of five beacon signals with the transmission interval pattern “0011” identified in step S520. That is to say, the predetermined transmission interval pattern stored in the information processing terminal 200 functions as an authentication pattern for authenticating the beacon device 100.

In the example of FIG. 5, the control device 220 calculates that the reception interval pattern of five beacon signals is “0011”. The control device 220 then determines that the reception interval pattern “0011” matches the identified transmission interval pattern “0011”. Thus, the control device 220 determines that the beacon device 100 is a legitimate device.

In step S550, the control device 220 references the transmission pattern table 244 to identify a character string (encryption key) that corresponds to the index number “4”. Further, the control device 220 uses the identified character string to decrypt the UUID and other data contained in the received beacon signal.

In step S560, the control device 220 executes a service that corresponds to the UUID derived from decryption. As an example, the control device 220 displays a coupon corresponding to the UUID on the display 230. More specifically, the control device 220 transmits the UUID to a server of a business operator corresponding to the company ID. The server then transmits a coupon corresponding to the UUID to the control device 220. The control device 220 eventually displays the received coupon on the display 230. As a result, the user of the information processing terminal 200 is able to receive a service based on the use of the beacon device 100.

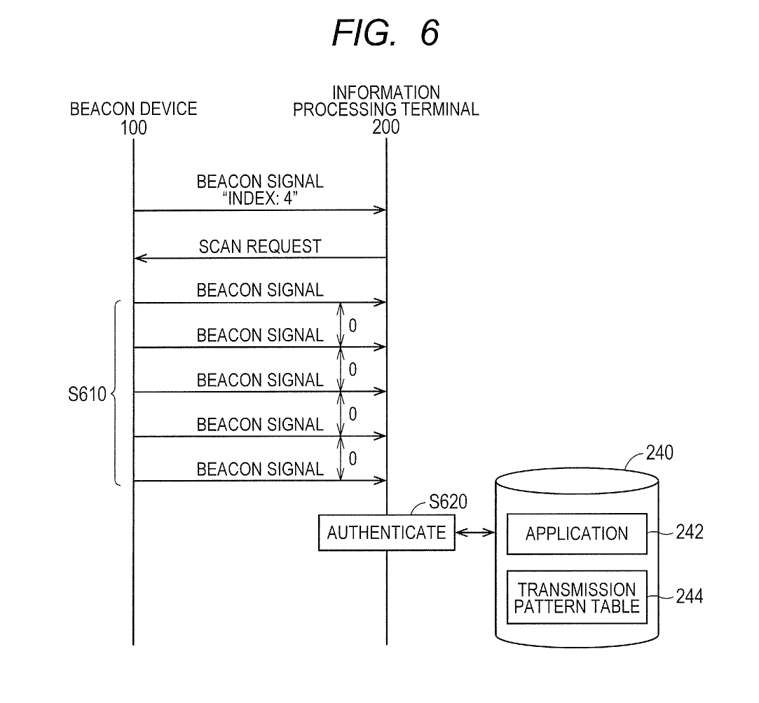

FIG. 6 is a sequence diagram illustrating the communication process in the wireless communication system 1. Processing steps that are shown in FIG. 6 and identical with those of the foregoing process are designated by the same reference numerals as their counterparts, and will not be redundantly described.

In step S610, the communication circuit in the beacon device 100 transmits a beacon signal containing the index number “4” in a transmission interval pattern of “0000”.

In step S620, based on five beacon signals received after the transmission of the scan request, the control device 220 authenticates whether the beacon device 100 is a legitimate device.

The control device 220 calculates that the five beacon signals obtained after the transmission of the scan request has a reception interval pattern of “0000”. The control device 220 then determines that the reception interval pattern “0000” does not match the transmission interval pattern “0011” corresponding to an index number of 4. Thus, the control device 220 determines that the beacon device 100 is an illegitimate device. As a result, the control device 220 does not perform any process based on the beacon signal received from the beacon device 100.

In another aspect, the control device 220 operates so that a beacon signal received from the beacon device determined to be illegitimate is transmitted to the server of the business operator corresponding to the company ID. This permits the business operator to grasp the existence of the illegitimate beacon device 100. In this instance, the control device 220 may transmit the beacon signal and position information to the server.

As described above, based on the transmission interval pattern of a beacon signal, the information processing terminal 200 according to the first embodiment is able to authenticate a beacon device that transmits the beacon signal. Therefore, a business operator supplying the beacon device 100 is able to inhibit spoofing by a malicious third party through the use of a simple configuration.

Further, the beacon device 100 according to the first embodiment changes the transmission interval pattern of the beacon signal. This permits the wireless communication system 1 to further inhibit a malicious third party from spoofing.

Furthermore, the wireless communication system 1 according to the first embodiment transmits and receives a beacon signal that is encrypted by a character string corresponding to an index number. This makes it possible to further inhibit a malicious third party from spoofing.

Moreover, upon receiving a scan request, the beacon device 100 according to the first embodiment starts transmitting a beacon signal at a time point predetermined by the transmission interval pattern. Therefore, based on a minimum number of beacon signals, the information processing terminal 200 is able to determine the reception interval pattern corresponding to the transmission interval pattern. That is to say, the wireless communication system 1 is able to reduce the time required for the process of authenticating the beacon device 100.

In another aspect, upon receiving the scan request, the beacon device 100 may not start outputting a beacon signal at a time point predetermined by the transmission interval pattern. In such an instance, the control device 220 calculates a predetermined period based on the transmission interval pattern.

In the example of FIG. 5, the beacon device 100 repeatedly outputs a 4-bit transmission interval pattern of “0011”. Therefore, no matter at what time point the beacon device 100 starts outputting a beacon signal, four bits corresponding to the transmission interval pattern “0011” are always contained in seven bits (eight beacon signals). If, for example, the beacon device 100 starts outputting “0110011” at the second bit, the fourth to seventh bits correspond to “0011”.

Consequently, the control device 220 performs the authentication process until a timeout occurs, that is, until the reception of a first predetermined number of beacon signals (eight beacon signals), which is determined by the transmission interval pattern. More specifically, the control device 220 authenticates the beacon device 100 by comparing the predetermined transmission interval pattern with the reception interval pattern of a predetermined number of successively received beacon signals (five beacon signals) as predetermined by the transmission interval pattern.

As is obvious from the above, even if the beacon device 100 does not start outputting a beacon signal at a predetermined time point, the information processing terminal 200 is able to authenticate the beacon device 100.

### Second Embodiment

The wireless communication system 1 according to a second embodiment of the present disclosure uses a communication channel to further inhibit a malicious third party from spoofing a beacon signal. The wireless communication system 1 according to the second embodiment has the same hardware configuration as the wireless communication system 1 according to the first embodiment.

The storage device 120 according to the second embodiment retains a transmission pattern table 124A instead of the transmission pattern table 124 described with reference to FIGS. 3A and 3B. The storage device 240 according to the second embodiment retains a transmission pattern table 244A instead of the transmission pattern table 244. The transmission pattern table 244A retains the same data as the transmission pattern table 124A.

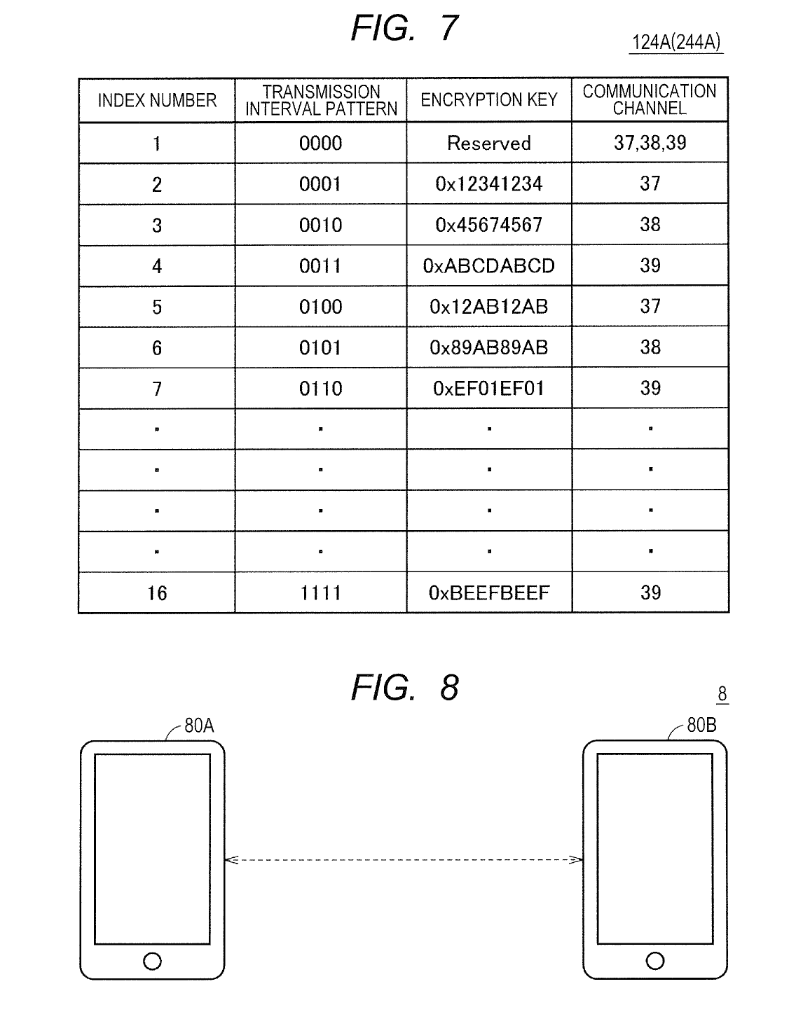

FIG. 7 illustrates an exemplary data structure of the transmission pattern table 124A (244A). The transmission pattern table 124A retains an index number, a transmission interval pattern, an encryption key, and a communication channel in association with each other.

The communication circuit 110 in the beacon device 100 sets a channel corresponding to an index number contained in a beacon signal as the communication channel for transmitting the beacon signal. For example, the communication circuit 110 transmits a beacon signal containing an index number of “4” to the information processing terminal 200 on a communication channel of “39”.

The control device 220 in the information processing terminal 200 references the transmission pattern table 244A to identify the communication channel “39” corresponding to the index number “4” contained in a received beacon signal.

The control device 220 authenticates the beacon device 100 by comparing the identified communication channel with a communication channel used to receive the beacon signal. More specifically, if the beacon signal is received on a communication channel other than the identified one, the control device 220 determines that the beacon device 100 at a transmitting end is an illegitimate device.

In general, beacon devices output an advertising packet on each of a plurality of communication channels. In the case of the BLE communication standard, three channels, namely, channels 37 to 39, are defined as advertising channels.

For example, the beacon device 100 outputs a beacon signal (advertising packet) containing an index number of “4” on each of communication channels 37, 38, and 39. In this instance, if the beacon signal is received on a communication channel other than communication channel 39, which corresponds to the index number “4”, that is, received on communication channel 37 or 38, the control device 220 determines that the beacon device 100 is an illegitimate device.

As is obvious from the above, the wireless communication system 1 according to the second embodiment is able to inhibit spoofing by a malicious third party through the use of a simple configuration.

### Third Embodiment

The wireless communication system 1 according to the foregoing embodiments authenticates the beacon device 100 in accordance with the beacon signal transmission interval pattern. A wireless communication system 8 according to a third embodiment of the present disclosure transmits and receives data by using the beacon signal transmission interval pattern.

In general, beacon devices are unable to easily change data contained in a beacon signal (hereinafter referred to also as the “beacon data”) (e.g., transmission data 122). Therefore, the wireless communication system 8 according to the third embodiment uses the beacon signal transmission interval pattern to transmit and receive data without changing the beacon data.

### (Wireless Communication System)

FIG. 8 illustrates an exemplary configuration of the wireless communication system 8 according to the third embodiment. The wireless communication system 8 includes information processing terminals 80A, 80B.

The information processing terminals 80A, 80B are each, for example, a smartphone, a tablet, or other mobile terminal carried by a user.

### (Information Processing Terminal)

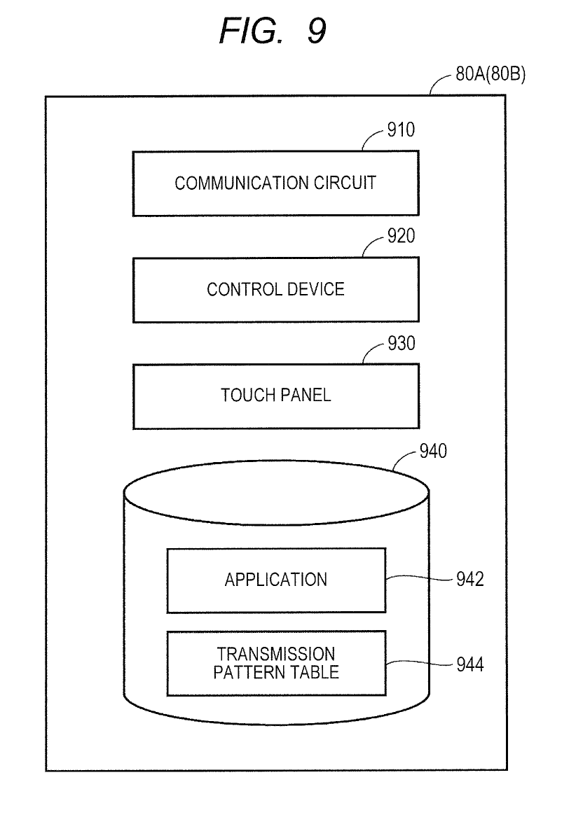

FIG. 9 is a block diagram illustrating an exemplary configuration of the information processing terminal 80A (80B). The information processing terminals 80A, 80B are hereinafter generically referred to also as an “information processing terminal 80”.

The information processing terminal 80 includes a communication circuit 910, a control device 920, a touch panel 930, and a storage device 940.

The communication circuit 910 communicates with another information processing terminal 80. The communication circuit 910 communicates with another information processing terminal 80 in accordance, for example, with the BLE communication standard.

The control device 920 is implemented, for example, by a CPU. The control device 920 controls the operation of the information processing terminal 80. The touch panel 930 includes a display and receives a user operation.

The storage device 940 stores an application 942 and a transmission pattern table 944. The control device 920 reads and executes the application 942 in order to communicate with another information processing terminal 80 through the communication circuit 910.

In the following description, the elements of the information processing terminal 80A are assigned reference numerals suffixed by the letter “A”, and the elements of the information processing terminal 80B are assigned reference numerals suffixed by the letter “B”. For example, the control device 920A is included in the information processing terminal 80A.

### (Transmission Pattern Table)

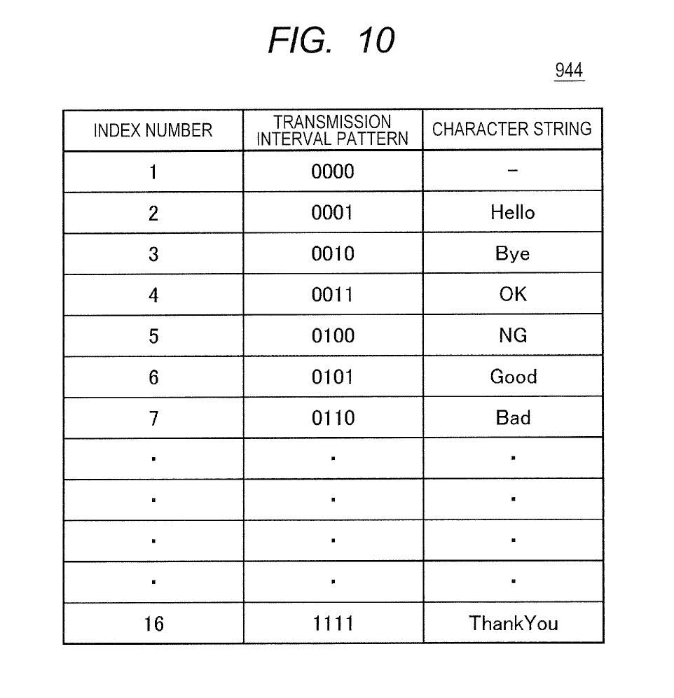

FIG. 10 illustrates an exemplary data structure of the transmission pattern table 944. Referring to FIG. 10, the transmission pattern table 944 retains a plurality of sets of an index number, a transmission interval pattern, and a character string in association with each other.

In the example of FIG. 10, the character string is a meaningful word (e.g., “Hello”). In another aspect, the character string is not limited to a word, but may be a UUID or other information necessary for providing a service.

### (Communication Process Between Information Processing Terminals)

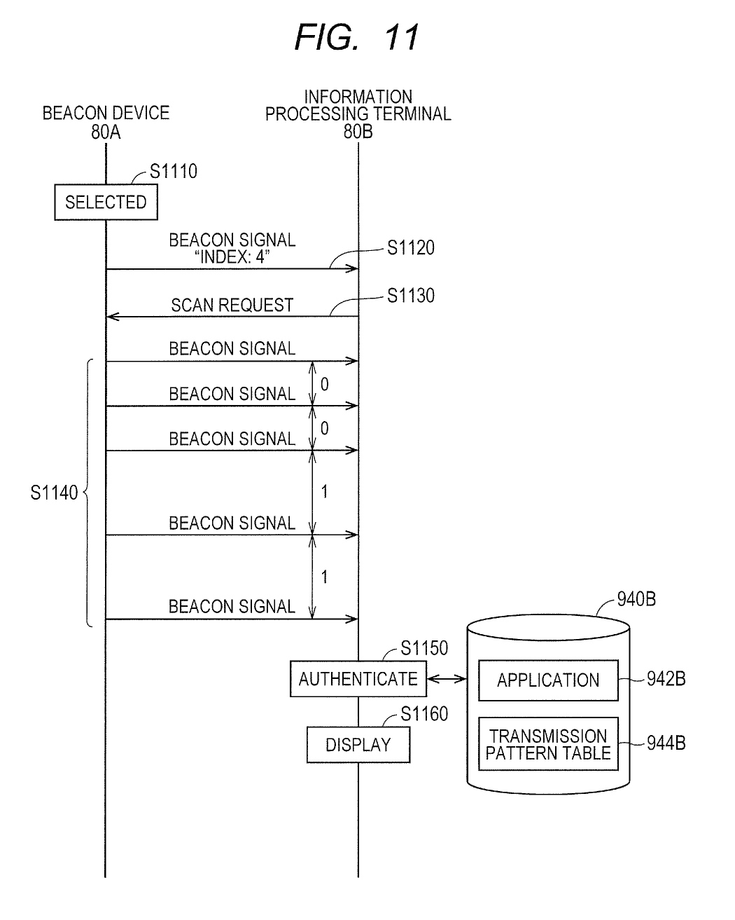

A communication process performed between the information processing terminal 80A and the information processing terminal 80B will now be described with reference to FIG. 11. FIG. 11 is a sequence diagram illustrating the communication process in the wireless communication system 8. The process illustrated in FIG. 11 is implemented by allowing the information processing terminals 80A, 80B to read and execute the application 942.

In step S1110, the control device 920A receives a user-selected character string to be transmitted to the information processing terminal 80B. In the process illustrated in FIG. 11, the user selects the character string “OK”.

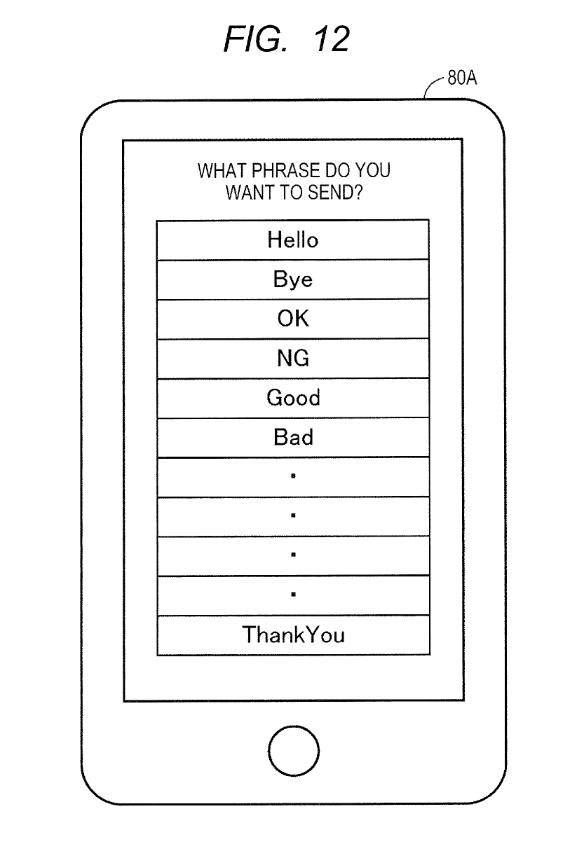

As illustrated, for example, in FIG. 12, the control device 920A displays a plurality of character strings retained by the transmission pattern table 944 on the touch panel 930A. The user touches a character string to be transmitted to the information processing terminal 80B. The touch panel 930A outputs information about a position touched by the user to the control device 920A. Based on the output from the touch panel 930a, the control device 920A receives the user-selected character string.

In step S1120, the control device 920A references the transmission pattern table 944A to identify the index number “4” and the transmission interval pattern “0011”, which correspond to the selected character string “OK”. The control device 920A transmits a beacon signal containing the index number “4” to the information processing terminal 80B through the communication circuit 910A.

In step S1130, upon receiving the beacon signal from the information processing terminal 80A, the control device 920B transmits a scan request to the information processing terminal 80A. Further, the control device 920B references the transmission pattern table 944B to identify the transmission interval pattern “0011”, which corresponds to the index number “4” contained in the beacon signal.

In step S1140, upon receiving the scan request, the control device 920A transmits a beacon signal to the information processing terminal 80B in accordance with the transmission interval pattern “0011”. In this instance, the control device 920A starts transmitting the beacon signal at the first bit “0” of the transmission interval pattern “0011”.

In step S1150, based on five beacon signals received after the transmission of the scan request, the control device 920B authenticates whether the information processing terminal 80A is a legitimate device or an illegitimate device.

More specifically, the control device 920B authenticates the beacon device 100 by comparing the reception interval pattern of the five beacon signals with the transmission interval pattern “0011” identified in step S520.

In the example of FIG. 11, the control device 920B determines that the reception interval pattern “0011” matches the identified transmission interval pattern “0011”. As a result, the control device 920B determines that the information processing terminal 80A is a legitimate device.

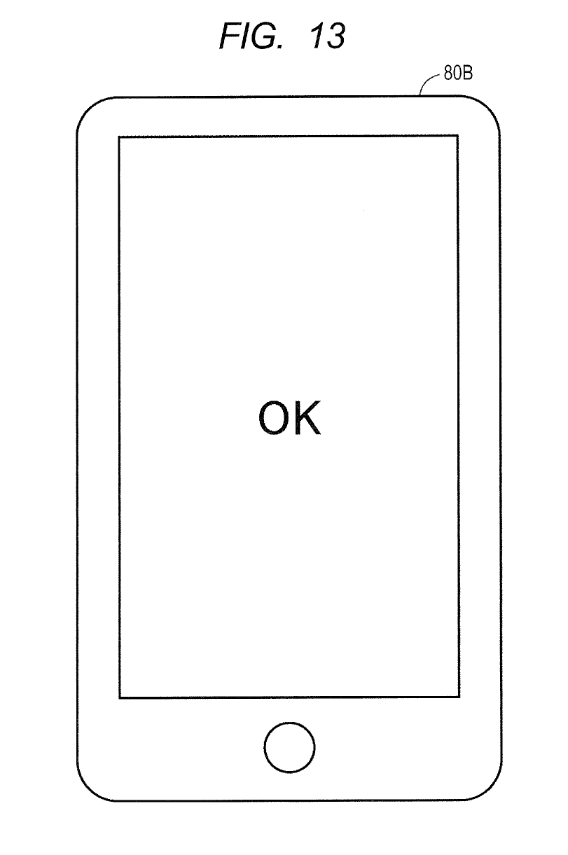

In step S1160, as the information processing terminal 80A is determined to a legitimate device, the control device 920B causes the touch panel 930B to display the character string “OK”, which corresponds to the index number “4” (FIG. 13).

As is obvious from the above, the wireless communication system 8 according to the third embodiment is able to handle the beacon signal transmission interval pattern as information (character string). Therefore, the wireless communication system 8 can easily change data to be substantially transmitted and received, simply by changing the beacon signal transmission interval pattern, without having to change the beacon data.

In addition, based on the transmission interval pattern, the wireless communication system 8 according to the third embodiment is able to authenticate the information processing terminal 80 at a beacon data transmitting end. Consequently, the wireless communication system 8 is able to inhibit spoofing by using a simple configuration.

### (Modification)

In the foregoing example, after receiving a user-selected character string, an information processing terminal 80 automatically transmits a beacon signal to another information processing terminal 80 in accordance with the transmission interval pattern.

The information processing terminal 80 according to a modification may receive a beacon signal transmission time point from the user.

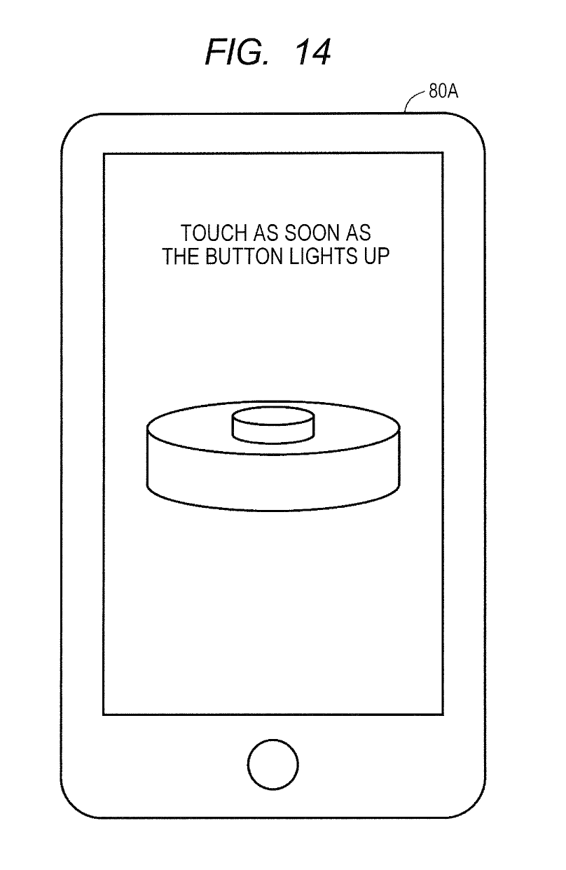

In the process illustrated in FIG. 11, for example, after receiving a user-selected character string in step S1110, the information processing terminal 80A further receives a selected transmission time point as illustrated in FIG. 14.

The control device 920A reports to the user a time point of the transmission interval pattern “0011” corresponding to the character string “OK” by using, for example, sound, light, or vibration. In accordance with the reported time point, the user touches an icon of a button displayed on the touch panel 930A. At a time point at which the icon is touched, the control device 920A transmits a beacon signal to the information processing terminal 80B. This permits the user to enjoy secrete communication with a user of another information processing terminal 80.

The foregoing description assumes that the authentication process is implemented by the control device 220 or control device 920 in the information processing terminal. However, the authentication process need not always be implemented by the control device 220 or control device 920. Various processing steps of the authentication process may be implemented by at least one processor or other semiconductor integrated circuit, at least one ASIC (application-specific integrated circuit), at least one DSP (digital signal processor), at least one FPGA (field-programmable gate array), and/or a different circuit having an arithmetic function.

The above circuits may be able to perform the various processing steps by reading one or more commands from at least one tangible readable medium.

The above-mentioned medium may be in the form of a magnetic medium (e.g., hard disk), an optical medium (e.g., compact disc (CD) or DVD), or a certain type of memory such as a volatile memory or a nonvolatile memory. However, the applicable medium is not limited to the above-mentioned forms.

The volatile memory may be a DRAM (dynamic random-access memory) or a SRAM (static random-access memory). The nonvolatile memory may be a ROM or an NVRAM. A semiconductor memory, together with at least one processor, may be a part of a semiconductor circuit.

While the present disclosure has been described in detail in terms of specific embodiments, the present disclosure is not limited to the foregoing embodiments. It is to be understood by those skilled in the art that various modifications can be made without departing from the spirit and scope of the present disclosure. Further, the foregoing embodiments and the modification may be combined as appropriate.

What is claimed is:

1. A wireless communication system comprising:
a beacon device; and
an information processing terminal that is capable of wirelessly communicating with the beacon device;
wherein the beacon device includes a first communication circuit for transmitting a beacon signal to the information processing terminal in accordance with a predetermined transmission interval pattern; and
wherein the information processing terminal includes:
a second communication circuit for receiving the beacon signal from the beacon device;
a first storage device for storing the predetermined transmission interval pattern; and
a control device that authenticates the beacon device by comparing a reception interval pattern of the beacon signal received by the second communication circuit with the predetermined transmission interval pattern stored in the first storage device.

2. The wireless communication system according to claim 1,
wherein the control device authenticates the beacon device until a timeout occurs in accordance with the predetermined transmission interval pattern by comparing the predetermined transmission interval pattern with the reception interval pattern of a predetermined number of successively received beacon signals as predetermined by the transmission interval pattern.

3. The wireless communication system according to claim 1,
wherein the beacon device further includes a second storage device for storing a table that associates each of a plurality of transmission interval patterns with pattern identification information for identifying the patterns,
wherein, in accordance with one of the transmission interval patterns stored in the second storage device, the first communication circuit transmits to the information processing terminal the beacon signal containing the pattern identification information associated with the one of the transmission interval patterns,
wherein the first storage device stores the table,
wherein the control device references the table stored in the first storage device to identify the transmission interval pattern corresponding to the pattern identification information contained in the received beacon signal, and
wherein the control device authenticates the beacon device by comparing the identified transmission interval pattern with the reception interval pattern.

4. The wireless communication system according to claim 3,
wherein the first communication circuit is capable of changing the transmission interval pattern of the beacon signal from a first pattern to a second pattern, the first and second patterns being among the transmission interval patterns stored in the second storage device.

5. The wireless communication system according to claim 3,
wherein the table stored in the first and second storage devices further retains each of a plurality of pieces of pattern identification information and communication channels in association with each other,
wherein the first communication circuit sets a communication channel for transmitting the beacon signal as the communication channel corresponding to the pattern identification information contained in the beacon signal,
wherein the control device references the table stored in the second storage device to identify the communication channel corresponding to the pattern identification information contained in the received beacon signal, and
wherein the control device authenticates the beacon device by comparing the identified communication channel with the communication channel used for receiving the beacon signal.

6. The wireless communication system according to claim 3,
wherein the table stored in the first and second storage devices further retains each of the pieces of pattern identification information and character strings in association with each other,
wherein, in accordance with one of the transmission interval patterns stored in the second storage device, the first communication circuit transmits to the information processing terminal a beacon signal that is encrypted by a character string corresponding to the pattern identification information associated with the one of the transmission interval patterns,
wherein the control device references the table stored in the first storage device to identify the character string corresponding to the pattern identification information contained in the received beacon signal, and
wherein the control device decrypts the received beacon signal by using the identified character string.

7. The wireless communication system according to claim 1,
wherein, upon receiving a predetermined signal from the information processing terminal, the first communication circuit starts transmitting the beacon signal to the information processing terminal at a time point predetermined by the predetermined transmission interval pattern.

8. The wireless communication system according to claim 3,
wherein the information processing terminal further includes a display,
wherein the table stored in the first and second storage devices further retains each of the pieces of pattern identification information and character strings in association with each other,
wherein the control device references the table stored in the first storage device to identify the character string corresponding to the pattern identification information contained in the received beacon signal, and
wherein the control device outputs the identified character string to the display.

9. A beacon device that is capable of wirelessly communicating with an information processing terminal,
wherein the information processing terminal is capable of authenticating the beacon device by comparing a reception interval pattern of a beacon signal received from the beacon device with an authentication pattern stored in a first storage device of the information processing terminal,
the beacon device comprising:
a storage device for storing a predetermined transmission interval pattern corresponding to the authentication pattern; and
a communication circuit for transmitting the beacon signal to the information processing terminal in accordance with a transmission interval pattern stored in the storage device.

10. An information processing terminal comprising:
a communication circuit for receiving a plurality of beacon signals from a beacon device;
a storage device for storing an authentication pattern used to authenticate the beacon device; and
a control device for authenticating the beacon device by comparing a reception interval pattern for receiving the beacon signal from the beacon device with the authentication pattern stored in the storage device.

11. A beacon device authentication method that is executed by an information processing terminal to authenticate a beacon device, the beacon device authentication method comprising the steps of:
receiving a plurality of beacon signals from the beacon device;
determining whether a reception interval pattern of the beacon signals matches an authentication pattern stored in a memory of the information processing terminal; and
if the reception interval pattern is determined to match the authentication pattern, performing a process based on the beacon signal.
